(19) United States
(12) Patent Application Publication
(10) Pub. No.: US 2020/0071845 A1
(43) Pub. Date: Mar. 5, 2020

(54) Plasma texturing and coating method for frictional and thermal management

(71) Applicants: Jingzeng Zhang, Windsor (CA); Yining Nie, New York, NY (US); Xueyuan Nie, Windsor (CA)

(72) Inventors: Jingzeng Zhang, Windsor (CA); Yining Nie, New York, NY (US); Xueyuan Nie, Windsor (CA)

(21) Appl. No.: 16/115,555

(22) Filed: Aug. 29, 2018

(51) Int. Cl. C25D 11/02; F02F 3/14; F02F 1/00; F02F 1/24; F02F 7/00

(52) U.S. Cl. CPC C25D 11/026; F02F 3/14; F02F 7/0087; F02F 1/24; F02F 1/004

(57) ABSTRACT

This invention involves a method of making a crater-like texture or a ceramic coating on a surface by electrolytic plasma discharging which occurs in fashion of micro-sized arcs distributing on the surface. The high temperature of plasma and high pressure of vapour bubbles of an electrolyte at the local discharging spots during the plasma activities cause micro-sized craters on the surface. Alternatively, using another selected electrolyte, the surface can also form a ceramic coating with a crater-like texture as its top layer. The surface can be polished, ground or honed afterward, and the surface shows improvements in friction, wear resistance, and heat transfer behavior.

### TECHNICAL FIELD

This invention involves a method of making a crater-like texture or coating on a component surface for performance improvement of friction and wear as well as thermal property and heat transfer behavior.

### BACKGROUND OF THE INVENTION

Friction and heat loss causes massive energy waste of internal combustion engine (ICE) and other machines which have rotating or sliding moving parts. The coefficient of friction quite depends on surface texture, morphology and surface roughness of those parts. To reduce the friction, much research has been placed on alternation of surface texture using various CNC machining, EDM (electrical discharging machining) patterning, chemical etching, and laser patterning. The texture can be a grooved, cross-hatched, squared, rectangular, triangular, dotted or dimpled shape with different size, depth and areal density. However, the above methods are usually costly or time-consuming; the drawbacks slow down the technology transferring process from research labs to industrial applications.

Right now, using internal combustion engine cylinder bore surface as example, the cross-hatching texture has been applied to cast iron engine bore surfaces; thermal spraying (PTWA for instance, US patent application number: 20160245224) coated engine bores also use the cross-hatching texture for friction reduction. An European automaker claims their thermal spraying coatings can have mirror finish with high surface porosity by appropriately controlling the coating process (i.e., H₂ and N₂ ratio in their combustion gases). The thermal spraying coating materials for current ICE bore applications are all steel-based.

Plasma electrolysis is a plasma surface treatment or coating process in a liquid solution environment [Nie, Yerokhin, Matthews, et al, Surf Coat Technol, Vol. 122, Page 73-93, 1999]. Depending on the component that is used as cathode or anode during the process, plasma electrolysis can be named cathodic or anodic plasma electrolysis. Cathodic plasma electrolysis has been proposed for surface cleaning, case hardening, or metal coating [Canadian patent: CA2474367A1]. However, the cathodic plasma electrolysis has not been proposed to amend surface texture for applications in frictional and thermal management.

Plasma electrolytic oxidation as an anodic plasma electrolysis has been proposed for generating ceramic oxide coatings on light metals (i.e., aluminum, titanium or magnesium alloys). The coating deposition process is relying on dielectric discharges of the passive and then oxide coating, leading to plasma oxidation of aluminum substrate, for example. The coating has a porosity required to provide high oil retention for friction reduction [Canadian patent number: CA2847014] or thermal barrier capability for low heat rejection loss [U.S. Pat. No. 10,030,314] particularly in ICE applications. However, the anodic plasma electrolysis has not been proposed to make ceramic coatings on cast iron and steel components for frictional and thermal management in automotive applications yet. In fact, it is very difficult to use the plasma electrolytic oxidation method to deposit ceramic coatings on an actual component made of the ferrous alloys although it may be possible to do that for a small sample of cast iron or steel.

In this invention, the operation process of plasma electrolysis is innovatively altered so that a modified electrolytic plasma discharging method can be used to make a crater-like texture and coating on a component surface. In said method, an electrolyte is sprayed onto local surface areas with a relatively small surface coverage size, which can avoid the need of a huge power supply for working on an actual component; otherwise, the plasma discharging can not be appropriately generated on the surface of a large component. The plasmas discharging occurs in fashion of micro-sized arcs distributing on the local surface areas being treated. The high temperature of plasma and high pressure of vapour bubbles at the local arc discharging spots during the plasma activities cause micro-sized craters on the surface. Alternatively, the surface can absorb chemical compounds from the electrolyte and form a ceramic coating with a crater-like texture as its top layer. After the surface is polished, ground or honed, the surface shows improvements in friction, wear resistance, and heat transfer behavior.

### SUMMARY OF THE INVENTION

The invention hereby deals with a method of making crater-like texture and coating on a component surface. This invented method is related to electrolytic plasma discharging, wherein said surface is connected to a power supply and in contact with an aqueous electrolyte. During the plasma discharging, the outmost layer of the surface is locally melt due to high temperature of plasma sparks, generating craters due to the collapse-induced pressure of vapour bubbles of the electrolyte; the melt is then solidified to have nanocrystalline structures which leads to have an increased surface hardness. Alternatively, chemical elements or compounds in the aqueous solution can be absorbed and sintered to form a ceramic coating on the component surface. After the surface is polished, ground or honed, the surface can have a mirror-like finish. The surface would show the improved friction and wear and temperature swing property.

In this invention, the method of making a crater-like texture comprises:
(i) preparing an electrolyte;
(ii) applying said electrolyte onto a surface of a metallic component,
(iii) applying a negative-bias voltage onto said component,
(iv) generating plasma discharges on the surface of said component,
(v) forming a crater-like texture on the said surface, and
(vi) post-grinding or post-honing the textured surface to have a mirror-like surface finish.

The said electrolyte is an aqueous solution containing 4-40 g/l sodium carbonate, sodium bicarbonate, potassium carbonate or potassium bicarbonate with possible additives of molybdenum and tungsten.

The said metallic component is made of cast iron (including grey, compact graphite, and ductile cast iron), steel, stainless steel, Ni alloy, super alloy, copper alloys, aluminum alloy, or titanium (Ti) alloy, or has a coating made of one of those alloys. Also, the said surface on the said component can pre-exist with a conductive top layer made of chrome, nickel, nitride case, CrN, CrAlN, CrTiAlN, CrSiAlN, TiN, TiCN, TiAlN, or carbon-based coatings.

The said electrical power provides the component with a voltage in range of 80-580 V of a DC or pulsed DC power with a current density of 0.05-5 A/cm².

The said crater-like texture has an areal density of 5-30% craters with diameter of 0.1-10 microns.

The said textured surface has nanocrystalline structures on its outmost surface layer and thus possesses increased surface hardness.

The said textured surface after post-grinding or post-honing has a surface roughness arithmetic average Ra in a rang of 0.1-1.0 micron, and oil retention value in a range of 0.1-0.5 micron³/micron².

The said post-ground or post-honed textured surface has a reduced (when lubricated) or increased (in dry air) friction by 30-50% and increased wear resistance by 100-300%, compared with an untreated surface of the same.

The post-ground or post-honed textured surface is implemented on engine cylinder bore surfaces, cylinder barrel, sleeve, bushing, journal bearing, piston pin bearing, piston pin, piston skirt, camshaft bearing, camshaft, crankshaft, gear, pump, turbocharge part, swashplate, ball-joint, spacer, slipper, slipper plate, brake disc or rotor.

Alternatively, a method of making a crater-like ceramic surface comprises:
(i) preparing an aqueous electrolyte,
(ii) applying said electrolyte onto a surface of a metallic component,
(iii) applying the component with a positive electrical voltage,
(iv) generating plasma discharging on said surface,
(v) forming a ceramic coating with crater-like texture on said surface, and
(vi) post-grinding or post-honing the textured coating surface when the component is used for friction applications.

The aqueous electrolyte is water dissolved with 4-40 g/l sodium aluminate, potassium aluminate, sodium silicate, potassium silicate, sodium phosphate, or potassium phosphate with or without additives of molybdenum and tungsten.

The said metallic component surface is made of cast iron (including grey, compact graphite, and ductile cast iron), steel, stainless steel, nickel alloy, super alloy, or copper alloy.

The said voltage is 80-580 V of a DC or pulsed DC power with a current density of 0.05-5 A/cm².

The said crater-like texture has an areal density of 5-40% craters with diameter of 0.1-10 microns.

The said ceramic coating has nanocrystalline structures with a coating thickness of 5-150 microns.

The said textured ceramic surface after the post-grinding or post-honing has a surface roughness arithmetic average Ra in a rang of 0.1-1.0 micron, and oil retention value in a range of 0.1-0.5 micron³/micron².

The said post-ground or post-honed textured ceramic surface has an increased wear resistance by 200-400% and a reduced or increased friction by 30-50%, depended on lubricating or dry sliding conditions, compared with an untreated surface of the same.

The post-ground or post-honed textured surface with the ceramic coating is implemented on engine cylinder bore surface, cylinder barrel, sleeve, bushing, piston pin bearing, piston pin, piston skirt, camshaft bearing, camshaft, swashplate, ball-joint, spacer, slipper plate, brake disc or rotor as well as piston dome, cylinder head combustion dome, and valve.

The said ceramic surface with or without the post-ground or post-honing operation has an improved friction as well as thermal barrier and temperature swing behaviors, which is beneficial in thermal efficiency enhancement when it is used for combustion environments.

### BRIEF DESCRIPTION OF THE DRAWINGS

FIG. 1 is a schematic illustration of a method for making a crater-like texture or coating on an inner surface of a metallic component in accordance with embodiments.

FIG. 2 is a schematic illustration of a method for making a crater-like texture or coating on an outer surface of a metallic component in accordance with embodiments.

FIG. 3 is a schematic illustration of a method for making a crater-like texture or coating on a flat surface of a metallic component in accordance with embodiments.

FIG. 4 is a schematic illustration of a cross-section of the textured component in accordance with embodiments.

FIG. 5 is a schematic illustration of a cross-section of the textured component with a ceramic surface coating in accordance with embodiments.

FIG. 6 is an image of a surface with a crater-like texture on a metallic component in accordance with embodiments.

FIG. 7 is an image of a surface with a crater-like texture on a ceramic-coated metallic component in accordance with embodiments.

### DETAILED DESCRIPTION OF THE INVENTION

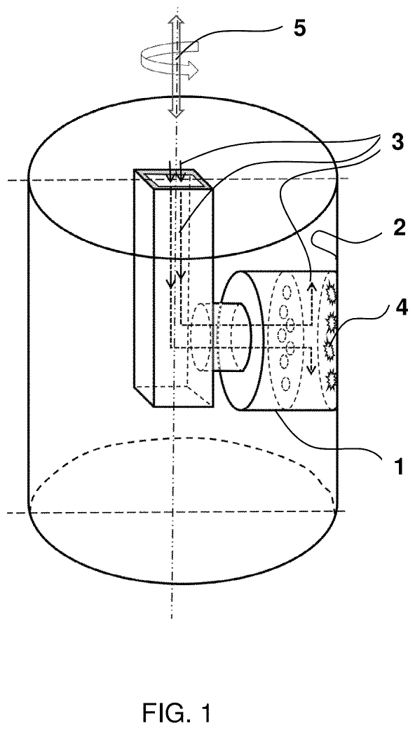

Referring to the schematic illustration in FIG. 1, a metallic spraying head 1 provides an inner surface 2 of a metallic component with an aqueous electrolyte 3; when a power supply applies electrical current and voltage between the spraying head 1 and the component 2, plasma discharges 4 are generated on the surface 2 of the component. The plasma discharges 4 are created by generating vapors and gases from the electrolyte on the surface 2 due to the heating from the applied electrical power energy initially and then breaking-down the vapors and gases under the applied voltage. Alternatively, the plasma discharges 4 can be created by absorbing at least one compound from the electrolyte to form a low electrical conductive layer on the surface 2 of the component first and then generating the electrical discharging due to the dielectric discharges of the layer under the applied voltage. The spraying head 1 can have motions 5 of rotations and moving up and down so that the entire inner surface 2 can be experienced with the plasma discharging treatment.

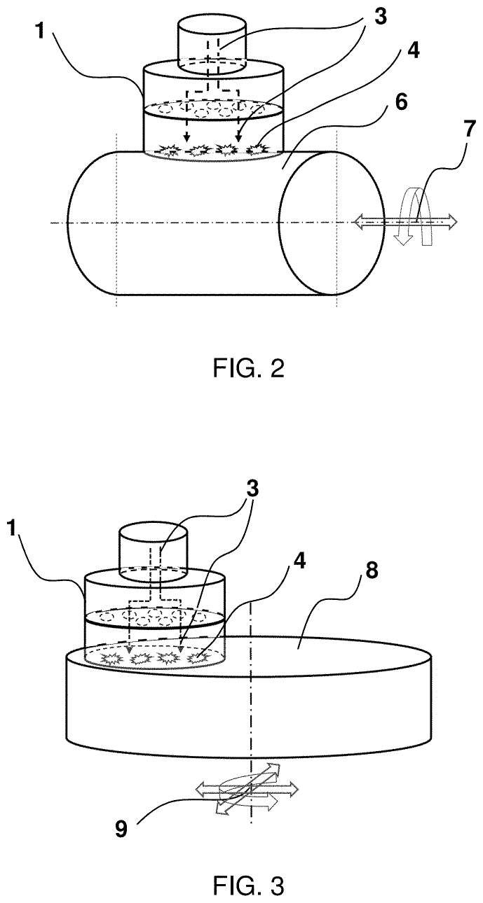

Referring to the schematic illustration in FIG. 2, a metallic spraying head 1 provides an external surface 6 of a metallic component with an aqueous electrolyte 3; when a power supply applies electrical current and voltage between the spraying head 1 and the component 6, plasma discharges 4 are generated on the surface 6 of the component. The plasma discharges 4 are created by generating vapors and gases from the electrolyte on the surface 6 due to the heating from the applied electrical power energy initially and then breaking-down the vapors and gases under the applied voltage. Alternatively, the plasma discharges 4 can be created by absorbing at least one compound from the electrolyte to form a low electrical conductive layer on the surface 6 of the component first and then generating the electrical discharging due to the dielectric discharges of the layer under the applied voltage. The spraying head 1 can have motions 7 of rotations and moving between left and right so that the entire external surface 6 can experience the plasma discharging treatment.

Referring to the schematic illustration in FIG. 3, a metallic spraying head 1 provides a flat surface 8 of a metallic component with an aqueous electrolyte 3; when a power supply applies electrical current and voltage between the spraying head 1 and the component 8, plasma discharges 4 are generated on the surface 8 of the component. The plasma discharges 4 are created by generating vapors and gases from the electrolyte on the surface 8 due to the heating from applied electrical power energy initially and then breaking-down the vapors and gases under the applied voltage. Alternatively, the plasma discharges 4 can be created by absorbing at least one compound from the electrolyte to form a low electrical conductive layer on the surface 8 of the component first and then generating the electrical discharging due to the dielectric discharges of the layer under the applied voltage. The spraying head 1 can have motions 9 of rotations and left-right or front-back movements so that the entire flat surface 8 can experience the plasma discharging treatment.

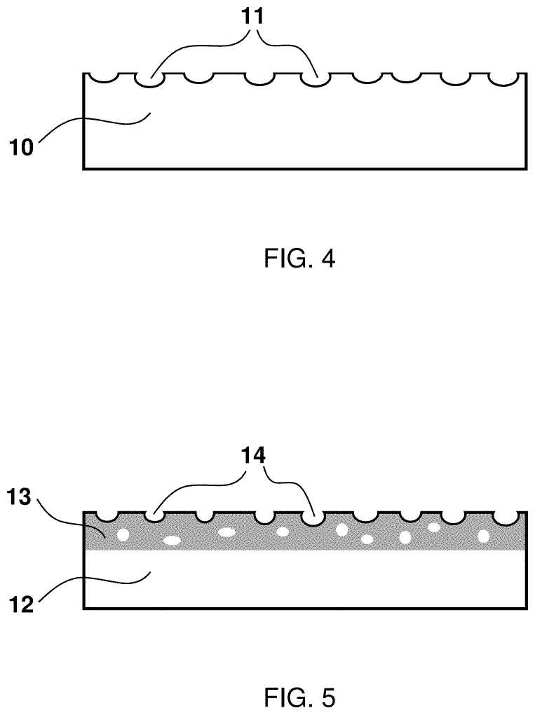

Referring to the schematic illustration in FIG. 4, a cross section near a surface of a component 10 after the above plasma discharging treatment (also called plasma texturing) shows existence of craters 11 in accordance with embodiments. Each of the craters is generated through each of the plasma discharging sparks 4 (FIGS. 1-3) that locally create high temperature and high pressure to melt the localized areas on surface 2, 6 or 8 (FIGS. 1-3) and subsequently solidify the melt materials at the corresponding locations. A mechanism of formation of the plasma discharging sparks 4 is that the applied electrical power energy creates vapors and gases by heating the electrolyte on the said surface initially and then breakdown the vapors and gases under the applied voltage to generate the plasma discharges. The said surface can have a nanocrystalline structure due to the fast melt-solidification process and a crater-like surface morphology due to the pressure generated from collapse of the gas bubbles.

Referring to the schematic illustration in FIG. 5, a cross section near a surface of a component 12 after the plasma discharging treatment (also called plasma coating) shows existence of a coating 13 with craters 14 in accordance with embodiments. Each of the craters is generated through each of the plasma discharging sparks 4 (FIGS. 1-3) that locally generates high temperature to sinter the coating on the localized surface 2, 6 or 8 (FIGS. 1-3). In this alternative case, a mechanism of formation of the plasma discharging sparks 4 is that at least one compound from the electrolyte is absorbed to form a low electrical conductive layer 13 on the said surface of the component firstly and then the dielectric discharges of the layer take place under the applied voltage, thus generating the plasma discharges. The said surface can have a nanocrystalline ceramic structure due to the fast sintering process and a crater-like surface morphology due to the vapour escaping from the coating. The coating thickness can be in an range of 5-150 microns.

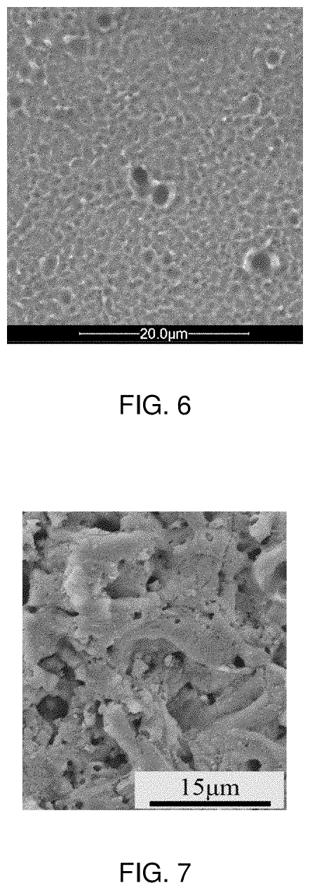

Referring to the illustration in FIG. 6, a scanning electron microscopic image shows existence of craters on a surface of a component after the plasma discharging treatment (also called plasma texturing) in accordance with embodiments. For the plasma texturing, the aqueous electrolyte is prepared with water dissolving 4-40 g/l sodium carbonate, sodium bicarbonate, potassium carbonate or potassium bicarbonate; the said component is made of cast iron, steel, stainless steel, nickel alloy, super alloy, copper alloy, aluminum alloy, or titanium (Ti) alloy; the said electrical voltage applied on the component is a DC (i.e., direct current) or pulsed DC voltage in a range of 80-580 V and its corresponding current density can be in a range of 0.05-5 A/cm²; and the crater-like texture has an areal density of 5-30% craters with diameter of 0.1-10 microns. The said textured surface has nanocrystalline structures on its outmost surface layer and thus possesses an increased surface hardness; the said textured surface after post-grinding or post-honing has a surface roughness arithmetic average Ra in a rang of 0.1-1.0 micron, and oil retention value in a range of 0.1-0.5 micron³/micron²; the said post-ground or post-honed textured surface has a reduced (when lubricated) or increased (in dry air) friction by 30-50% and increased wear resistance by 100-300%, compared with an untreated surface of the same; and the post-ground or post-honed textured surface is implemented on engine cylinder bore surfaces, cylinder barrel, sleeve, bushing, journal bearing, piston pin bearing, piston pin, piston skirt, camshaft bearing, camshaft, crankshaft, gear, pump, turbocharge part, swashplate, ball-joint, spacer, slipper, slipper plate, or brake rotors.

Referring to the illustration in FIG. 7, a scanning electron microscopic image shows a ceramic-coated surface with crater-like texture on a component after the plasma discharging treatment (also called plasma coating) in accordance with embodiments. For the plasma coating, the aqueous electrolyte is firstly prepared with water dissolving 4-40 g/l sodium aluminate, potassium aluminate, sodium silicate, potassium silicate, sodium phosphate, or potassium phosphate with possible additives of molybdenum and tungsten; the said applied voltage is 80-580 V of a DC or pulsed DC power with an initial current density up to 3-5 A/cm² followed by a current density of 0.05-0.5 A/cm²; and the said crater-like texture has an areal density of 5-40% craters with diameter of 0.1-10 microns; the said ceramic coating has nanocrystalline structures. The said textured ceramic surface after the post-grinding or post-honing has a surface roughness arithmetic average Ra in a rang of 0.1-1.0 micron, and oil retention value in a range of 0.1-0.5 micron³/micron²; the said post-ground or post-honed textured ceramic surface has a reduced (when lubricated) or increased (in dry air) friction by 30-50% and increased wear resistance by 200-400%, compared with untreated surface of the same; the post-ground or post-honed textured surface with the ceramic coating is implemented on engine cylinder bore surface, cylinder barrel, sleeve, bushing, piston pin bearing, piston pin, piston skirt, camshaft bearing, gear, pump, turbocharge part, swashplate, ball-joint, spacer, slipper plate, or brake discs as well as piston dome, cylinder head combustion dome, and poppet valve; and the said ceramic surface with or without the post-ground or post-honing operation has an improved friction as well as thermal barrier and temperature swing behaviors, which is beneficial in automotive applications. The coating thickness can be in a range of 5-150 microns.

In accordance with embodiments of this invention, the electrolyte is for generating a liquid-gas-plasma 3-phase co-existing environment so the plasma texturing and coating process can take place. The electrolyte can have a composition and concentration different from those stated above. However, any electrolyte used for creating a liquid-gas-plasma environment and generating plasma discharges for the plasma texturing and coating purpose should be accounted into this invention.

In accordance with embodiments of this invention, the electrolyte for the plasma texturing and coating process can be applied onto the surface to be treated through either a spraying or immersing method, depended on the component size and available capability of electrical power supply. When the component is relatively small, the component surface can be immersed into the electrolyte more conveniently for the plasma texturing and coating process.

In accordance with embodiments of this invention, the surface after the plasma texturing process can have a mirror-like surface finish after a post-grinding or post-honing operation; the mirror-like finished surface has a reduced friction in lubricating sliding conditions, resulting in a low friction loss. Such a textured surface with a mirror-like finish can be applied on cylinder bore, piston skirt, shaft, bearing, and other sliding couplings.

In accordance with embodiments of this invention, the surface after the plasma coating process can have a mirror-like surface finish after a post-grinding or post-honing operation; the mirror-like finished coating surface has a reduced friction in lubricating sliding conditions, resulting in a low friction loss. Such a textured coating surface with a mirror-like finish can be applied on cylinder bore, piston skirt, shaft, bearing, and other sliding couplings.

In accordance with embodiments of this invention, the surface after the plasma coating process can have a relatively rough surface finish of Ra=1.0-3.0 microns before a post-grinding or post-honing operation; the rough ceramic coating surface can have an increased hardness and friction in a non-lubricating sliding condition, resulting in an improved wear resistance and braking power. Also, the coated component can have an enhanced corrosion resistance. These benefits can be used for reducing the formation of wear debris of a brake disc or rotor, leading to less discharges of airborne soot, as an example.

In accordance with embodiments of this invention, the surface after the plasma coating process can have a low thermal conductivity of 1.0-10 Walt per meter per Kelvin (W/m·K); the ceramic coating can be used as a thermal barrier coating (TBC) and have a temperature swing behavior for combustion chamber walls of an internal combustion engine. Such a coating surface can be applied on cylinder bore, piston dome, combustion dome on cylinder head, poppet valve, turbo and other components that need a tailored thermal management for a better engine efficiency.

1. A method of making a crater-like textural surface, comprising
(i) preparing an aqueous electrolyte,
(ii) applying said electrolyte onto a surface of a metallic component,
(iii) applying the metallic component with a negative electrical voltage,
(iv) generating plasma discharging on said surface,
(v) forming a crater-like texture on said surface, and
(vi) post-grinding or post-honing the textured surface.

2. The method as claimed in claim 1, wherein said aqueous electrolyte is water dissolved with 4-40 g/l sodium carbonate, sodium bicarbonate, potassium carbonate or potassium bicarbonate with or without additives of molybdenum and tungsten.

3. The method as claimed in claim 1, wherein said metallic component surface is made of cast iron (including grey, compact graphite, and ductile cast iron), steel, stainless steel, nickel alloy, super alloy, copper alloy, aluminum alloy, or titanium (Ti) alloy.

4. The method claimed in claim 1, wherein said surface on the said component can pre-exist with a conductive top layer made of chrome, nickel, nitride case, CrN, CrAlN, CrTiAlN, CrSiAlN, TiN, TiCN, TiAlN, or carbon-based coatings.

5. The method as claimed in claim 1, wherein said voltage is 80-580 V of a DC or pulsed DC power with a current density of 0.05-5 A/cm².

6. The method as claimed in claim 1, wherein said crater-like texture has an areal density of 5-30% craters with diameter of 0.1-10 microns.

7. The method as claimed in claim 1, wherein said textured surface has nanocrystalline structures on its outmost surface layer and thus possesses an increased surface hardness.

8. The method as claimed in claim 1, wherein said textured surface after post-grinding or post-honing has a surface roughness arithmetic average Ra in a rang of 0.1-1.0 micron, and oil retention value in a range of 0.1-0.5 micron³/micron².

9. The method as claimed in claim 1, wherein said post-ground or post-honed textured surface has a reduced (when lubricated) or increased (during the dry sliding) friction by 30-50% and an increased wear resistance by 100-300%, compared with an untreated surface of the same.

10. The method as claimed in claim 1, wherein post-ground or post-honed textured surface is deposited on engine cylinder bore surface, cylinder barrel, sleeve, bushing, journal bearing, piston pin bearing, piston pin, piston skirt, camshaft bearing, camshaft, crankshaft, gear, pump, turbocharge part, swashplate, ball-joint, spacer, slipper, slipper plate, brake disc or rotor.

11. A method of making a crater-like ceramic coating surface, comprising
(i) preparing an aqueous electrolyte,
(ii) applying said electrolyte onto a surface of a metallic component,
(iii) applying the surface with a positive electrical voltage,
(iv) generating plasma discharging on said surface,
(v) forming a ceramic coating with crater-like texture on said surface, and
(vi) post-grinding or post-honing the textured coating surface when the component is used for friction applications.

12. The method as claimed in claim 11, wherein said aqueous electrolyte is water dissolved with 4-40 g/l sodium aluminate, potassium aluminate, sodium silicate, potassium silicate, sodium phosphate, or potassium phosphate with additives of molybdenum and tungsten.

13. The method as claimed in claim 11, wherein said metallic component surface is made of cast iron (including grey, compact graphite, and ductile cast iron), steel, stainless steel, nickel alloy, super alloy, or copper alloy.

14. The method as claimed in claim 11, wherein said voltage is 80-580 V of a DC or pulsed DC power with a current density of 0.05-5 A/cm².

15. The method as claimed in claim 11, wherein said crater-like texture has an areal density of 5-40% craters with diameter of 0.1-10 microns.

16. The method as claimed in claim 1, wherein said ceramic coating has nanocrystalline structures with the coating thickness of 5-150 microns.

17. The method as claimed in claim 11, wherein said textured ceramic coating surface after post-grinding or post-honing has a surface roughness arithmetic average Ra in a rang of 0.1-1.0 micron, and oil retention value in a range of 0.1-0.5 micron³/micron².

18. The method as claimed in claim 11, wherein said post-ground or post-honed textured ceramic surface has a reduced (when lubricated) or increased (during the dry sliding) friction by 30-50% and an increased wear resistance by 200-400%, compared with an untreated surface of the same.

19. The method as claimed in claim 11, wherein said ceramic coating surface can have a thermal conductivity of 1.0-10 W/m·K, which is used as a thermal barrier coating (TBC) and has a temperature swing behavior for combustion chamber walls of an internal combustion engine.

20. The method as claimed in claim 11, wherein said ceramic coating surface is deposited on engine cylinder bore, cylinder barrel, sleeve, bushing, piston pin bearing, piston pin, piston skirt, camshaft bearing, gear, pump, turbocharge part, swashplate, ball-joint, spacer, slipper plate, brake disc or rotor as well as piston dome, cylinder head combustion dome, and valve.
